(19) United States
(12) Patent Application Publication
(10) Pub. No.: US 2009/0308309 A1
(43) Pub. Date: Dec. 17, 2009

(54) Flocked applicator and method of making

(76) Inventor: Mohamed Abdel Aziz, Oakdale, MN (US)

Correspondence Address: Thomas N. Phung;Jacobson and Johnson, Suite 285, One West Water Street, St. Paul, MN, 55107-2080, US

(21) Appl. No.: 12/456,214

(22) Filed: Jun. 12, 2009

Related U.S. Application Data
(60) Provisional application No. 61/131,956, filed on Jun. 13, 2008.

(51) Int. Cl. B05C 17/10; B05D 1/16

(52) U.S. Cl. 118/264; 427/462

(57) ABSTRACT

A coating applicator tool and a method of making coating applicator tool with the coating applicator tool comprising a base member having a first surface and a second surface, a handle connected to the second surface of the base member and a plurality of flocked fibers supported on the first surface of the base member with the flocked fibers maintaining coating materials to a coating-receiving surface and distributing coating materials to the coating-receiving surface.

### CROSS REFERENCE TO RELATED APPLICATIONS

This application claims priority to currently pending U.S. Provisional Application Ser. No. 61/131,956; filed on Jun. 13, 2008; titled FLOCKED APPLICATOR TOOL AND METHOD OF MAKING.

### FIELD OF THE INVENTION

This invention relates generally to coating applicator tools and more specifically to a coating applicator tool having flocked fibers that are applied to an applicating surface of the coating applicator tool.

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

Tools having fibered applicating surfaces for applying surface coating are known in the art. The aforementioned tools are generally formed from a substrate comprising a roll of fabric having fibers that are continuously woven to form a plurality of loops throughout the fabric after which the top of each of the loop of the woven fibers are shaved off to form a velour or bristled like texture surface. The roll of fabric is then cut to size and secured to a base member of an applicator tool through the use of an adhesive. It should be noted that the fibers may alternatively be knitted onto the fabric.

The above coating tools alternatively may also be formed by electrostatic flocking a plurality of fibers onto a foam substrate and then securing the fiber flocked foam substrate to a base member of an applicator tool by a variety of methods including but not limited to the use of the adhesive and through a frictional fit. Although the aforementioned tools generally work for their intended purposes, one of the main limitations of the prior art coating applicator tools is that they tend to have a shorter use life when use in the application of heavy and/or corrosive solvents. For example, it has been found that the presence of certain coating solvents may cause the adhesive binding the woven fabric to the base member of the coating applicator tool to break down, resulting in the woven fabric coming off of the base member of the coating applicator tool. In addition, certain coating solvents have been known to eat through the woven fabric.

It has also been found that coating applicator tools containing the fiber flocked foam substrate also offers limitations in the application of heavy coating solvents as the foam substrate has a tendency to swell and weaken during the surface application process. That is the foam has a tendency tear when coating very rough or abrasive surfaces. Also, the foam can come loose from the tool when used in heavy solvent.

The present invention provides a solution to the above problems by providing a coating applicator tool having flocked fibers that are applied to an applicating surface of the coating applicator tool that is durable and is resistant to damage in the application of heavy coating solvents or when used in very rough or abrasive surfaces so as to eliminate the need for the foam substrate or a woven fabric substrate. Eliminating the foam substrate and the woven fabric substrate allows the coating applicator tool of the present invention to be effectively used not only with traditional coating materials such as paint and oils but also with heavier and more corrosive coating solvents. In addition, eliminating the foam substrate and the woven fabric substrate reduces manufacturing cost while providing for a coating applicator tool that comprises a lower profile to enable the tool access to surface regions where traditional applicator tool are unable to reach doe to their profile.

### BRIEF SUMMARY OF THE INVENTION

The present invention comprises a coating applicator tool having a base member with a first surface and a second surface. The second surface of the base member includes a handle connected thereto. The first surface of the base member includes a plurality of flocked fibers supported thereon with the flocked fibers maintaining coating materials to a coating-receiving surface and distributing coating materials to said coating-receiving surface. The coating applicator tool may include a replaceable coating pad removably secured to the first surface of said base member with the replaceable coating pad having a surface supporting the flocked fibers thereon.

The present invention may also comprise a coating applicator tool having a base member with a first surface and a second surface. The second surface of the base member includes a handle connected thereto. The coating applicator tool also includes a replaceable coating pad comprising a hook-and-loop fastener. The replaceable coating pad includes a first surface securable to the first surface of the base member by a pressure contact and a second surface supporting a plurality of flocked fibers thereon with the flocked fibers maintaining coating materials to a coating-receiving surface and distributing coating materials to said coating-receiving surface. The replaceable coating pad may comprise a first side having a plurality of tiny hooks extending therefrom and a second side having a plurality of small hair-like loops extending therefrom.

The present invention may also include a method of making a coating applicator tool including the steps of coating a plurality of flocking fibers with a medium to make the flocking fibers electrically conductive or charged, coating a surface of a substrate with an adhesive, directing the adhesively coated surface of the substrate through a static charged field, to electronically drawing and embedding the flocking fibers to the adhesively coated surface of the substrate, hardening the adhesive on the substrate; and prepping the substrate to form the coating applicator tool.

### BRIEF DESCRIPTION OF THE DRAWINGS

FIG. 1 is a side view showing an embodiment of the coating applicator tool;

FIG. 2 shows a top view of a coating applicator tool similar to the coating applicator tool of FIG. 1;

FIG. 3 shows a side view of a coating applicator tool similar to the coating applicator tool of FIG. 1;

FIG. 4 shows a partial cross-sectional view of a roller applicator having a roller insert with a fiber flocked exterior surface;

FIG. 5 shows a cross-sectional view of the roller insert of FIG. 4;

FIG. 6 shows a side view of a coating applicator tool similar to the coating applicator tool of FIG. 3;

FIG. 7 shows a side view of a portion of replaceable coating pad;

FIG. 8 shows a side view of a coating applicator tool having a hook-and-loop fastener based replaceable coating pad secured thereto;

FIG. 9 shows a cross-sectional view of an alternative embodiment of a roller insert having a replaceable coating pad secured thereto;

FIG. 10 shows a side view of a replaceable coating pad having a first side containing a plurality of tiny hooks and a second side having fibers directly flocked thereto; and

FIG. 11 shows a side view of a replaceable coating pad having a first side containing a plurality of small hair-like loops and a second side having fibers directly flocked thereto.

### DESCRIPTION OF THE PREFERRED EMBODIMENT

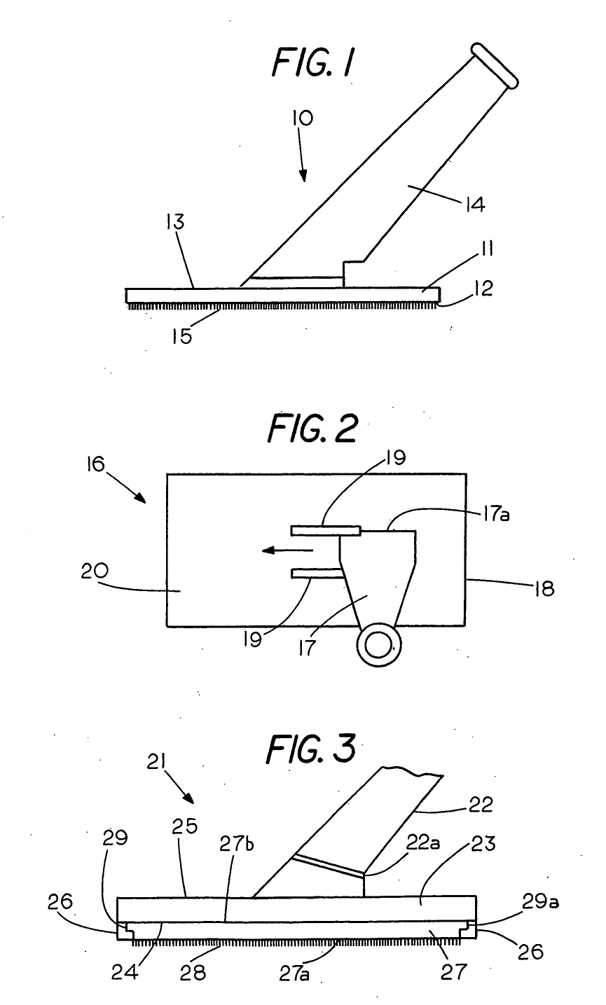

Referring to the drawings, FIG. 1 is a side view showing an embodiment of a coating applicator tool 10 comprising a combination coating pad and rigid base member 11. It is noted that alternative embodiments may comprise a flexible base member instead of a rigid base member 11. Coating pad and rigid base member 11 includes a first surface 12 and a second surface 13 with the second surface 13 having a handle 14 secured thereto. A feature of the present invention is that the first surface 12 of the base member 11 includes a plurality of fibers 15 that are directly flock thereto with the flocked fibers 15 functioning to help maintain the loaded coating material to the coating-receiving surface such as a wall or a floor while also acting as a brush for the applicator. Directly flocking the flocked fibers 15 to base member 11 also provides coating applicator tool 10 with increase durability and resistance to damage such as when used in the application of heavy coating solvents or when used in very rough or abrasive surfaces.

FIG. 2 shows a top view of an alternative embodiment of a coating applicator tool 16 of the present invention similar to the coating applicator tool 10 of FIG. 1. However the coating applicator tool 16 of FIG. 2 includes a handle 17 that is removable attachable to a base member 18 through a sliding engagement of an attaching end 17a of the handle 17 with a pair of slots 19 located on a second surface 20 of the base member 18 of coating applicator tool 16. The removability of the handle 17 allows for the replacement of an old or used coating pad and base member 18 with a fresh coating pad and base member 18.

FIG. 3 shows a side view of an alternative embodiment of a coating applicator tool 21 similar to the coating applicator tool 10 of FIG. 1. However in the embodiment of FIG. 3 a handle 22 is shown permanently secured to a second surface 25 of a base member 23 with the handle 22 having a joint 22a that allows the base member 23 to swivel thereabout. In addition, unlike the coating applicator tool 10 of FIG. 1, the first surface 24 of the base member 23 is not directly flocked with fibers. Instead the first surface 24 of the base member 23 includes a set of parallel slots 26 extending from the first surface 24 of the base member 23 for securing a replaceable coating pad 27 to the first surface 24 of the base member 23.

In regards to the replaceable coating pad 27, as shown in FIG. 3, the replaceable coating pad 27 comprises a first surface 27a and a second surface 27b with the first surface 27a having a plurality of fibers 28 that are directly flock thereto. The flocked fibers 28 functioning to help maintain the loaded coating material to the coating-receiving surface such as a wall or a floor while also acting as a brush for the applicator. A feature of coating pad 27 is that coating pad 27 durable and resistant to damage such as when used in the application of heavy coating solvents or when used in very rough or abrasive surfaces. The replaceable coating pad 27 also includes a pair of arms 29, 29a extending from the ends of the replaceable coating pad 27 for engaging the corresponding slots 26 of the base member 27 to secure the replaceable coating pad 27 to the first surface 24 of the base member 23.

Referring to FIGS. 4 and 5, FIG. 4 shows a partial cross-sectional view of a roller applicator 30 and FIG. 5 shows a cross-sectional view of a roller insert 31 of the present invention. The roller insert 31 comprises cylindrically shaped, preferably replaceable coating pad and base member 32. Coating pad and base member 32 includes an applicating surface 33 having a plurality of fibers 34 that are directly flock thereto. The flocked fibers 34 function to distribute coating materials to a surface such as a wall or a floor. It is noted that the cylindrically shaped base member 32 may be formed from a plurality of materials such as but not limited to various types of plastic and phenolic paper, depending upon the type of coating material that is intended for application by the roller applicator. It is also noted that although cylindrically shaped base member 32 is described as preferably comprising a replaceable coating pad material, the cylindrically shaped base member alternatively may be formed from a flexible material such as but not limited cardboard, elastomeric materials, and various types of flexible plastics so long as the material is durable and resistant to damage such as when used in the application of heavy coating solvents or when used in very rough or abrasive surfaces.

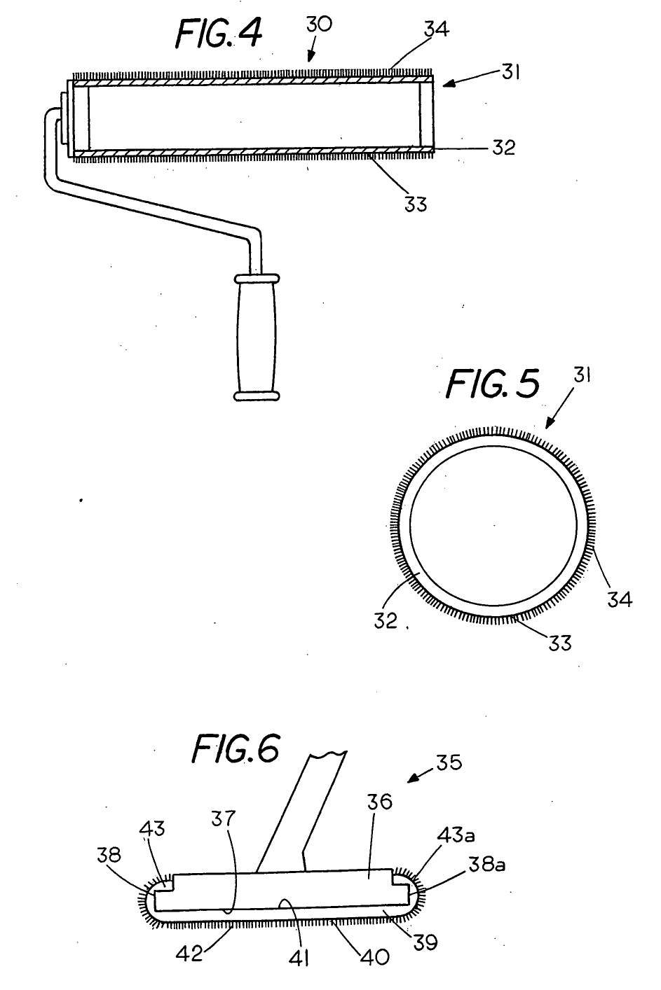

FIG. 6 shows a side view of an alternative embodiment of a coating applicator tool 35 similar to the coating applicator tool 21 of FIG. 3 in that a first surface 37 of a base member 36 is not directly flocked with fibers. The first surface 37 of the base member 36 instead includes a set of arms 38, 38a extending from the ends of the base member 36 for securing a replaceable coating pad comprising a metal plate 39 to the first surface 37 of the base member 36. Although the replaceable coating pad of coating applicator tool 35 comprises metal plate 39, the replaceable coating pad alternatively may be form from other materials including but not limited to metal, wood, plastic, various types of natural fibers, natural cellulose, and phenolic paper.

In regards to the metal plate 39, as shown in FIG. 6, the metal plate comprises a first surface 40 and a second surface 41 with the first surface 40 having a plurality of fibers 42 directly flocked thereto with the flocked fibers 42 functioning to help maintain the loaded coating material to the coating-receiving surface such as a wall or a floor while also acting as a brush for the applicator. The metal plate 39 is shown manipulated to form a pair of curve-shaped ends 43, 43a for engaging the corresponding arms 38, 38a of the base member 36 to secure the metal plate 39 to the first surface 37 of the base member 36.

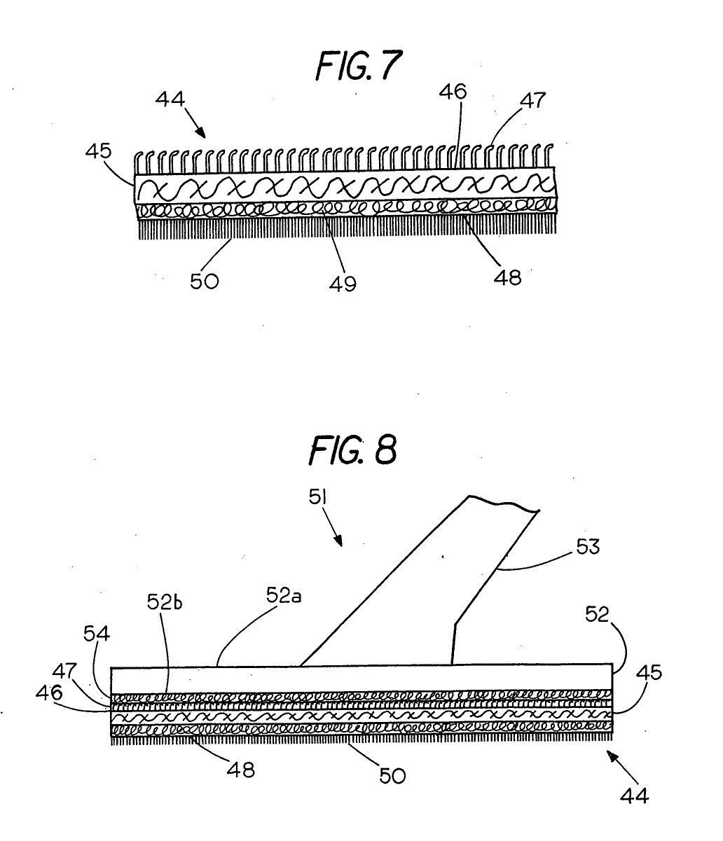

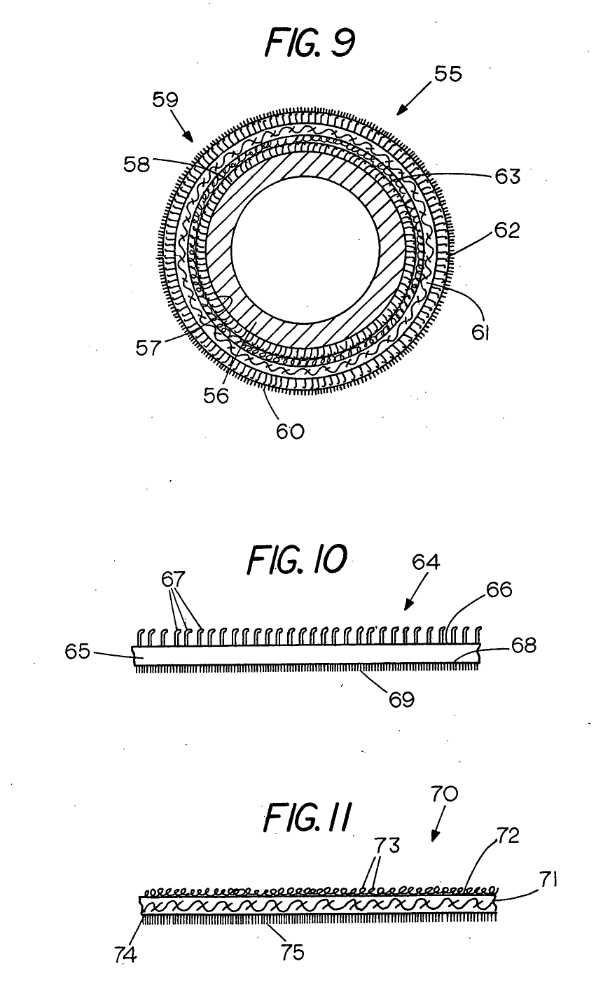

FIG. 7 shows a side view of a portion of a replaceable coating pad 44 of the present invention. Replaceable coating pad 44 generally comprises a hook-and-loop fastener having a layer of fabric 45 with a hook side 46 identified by a plurality of tiny hooks 47 of plastic or the like extending therefrom and a loop side 48 identified by a plurality of small hair-like loops 49 extending therefrom. It is noted that hook-and-loop fasteners are generally identified or known by the brand name Velcro®, which is owned by the company Velcro Industries of the Netherlands. A feature of the embodiment of FIG. 7 is that the replaceable coating pad 44 of FIG. 7 includes a plurality of fibers 50 that are directly flocked to the loop side 48 of the layer of fabric 45 with the flocked fibers 50 functioning to help maintain the loaded coating material to the coating-receiving surface such as a wall or a floor while also acting as a brush for the applicator. The selection of hook-and-loop fastener-based replaceable coating pad 44 is desired for the present invention as the hook-and-loop fastener-based replaceable coating pad 44 may be form from a material(s) that have increase durability and resistance to damage such as when used in the application of heavy coating solvents or when used in very rough or abrasive surfaces.

FIG. 8 shows a side view of a coating applicator tool 51 similar to the coating applicator tool 10 of FIG. 1 in that coating applicator tool 51 comprises a base member 52 having a first side 52a and a second side 52b. Attached to the first side 52a of base member 52 is a griping handle 53 and extending from the second side 52b of base member 52 is a plurality of small hair-like loops 54 having qualities similar to the small hair-like loops 49 of the replaceable coating pad 44 of FIG. 7. The plurality of small hair-like loops 54 of coating applicator tool 51 function to secure the replaceable coating pad 44 to the base member 52 of coating applicator tool 51 when the hook side 46 of the replaceable coating pad 44 is pressed against the second side 52b coating applicator tool 51 causing the plurality of tiny hooks 47 of the replaceable coating pad 44 to catch in the plurality of small hair-like loops 54 of coating applicator tool 51. Durability of coating applicator tool 51 is enhance as coating applicator tool 51 does not require the use adhesives to replaceable coating pad 44 to base member 52 thereby eliminating the connection site between replaceable coating pad 44 and base member 52 from potential attach by heavy and/or corrosive solvents.

Once the replaceable coating pad 44 is no longer usable, replaceable coating pad 44 may be easily replaced with a fresh replaceable coating pad 44 by simply separating the used coating pad 44 from the base member 52 and securing a fresh replaceable coating pad 44 to the base member 52.

FIG. 9 shows a cross-sectional view of an alternative embodiment of a roller insert 55 having a replaceable coating pad 59 secured thereto. Replaceable coating pad 59 is similar to the replaceable coating pad 44 of FIG. 7 except that a plurality of fibers 60 are directly flocked to a hook side 62 of a layer of fabric 61 instead of a loop side 63 of the layer of fabric 61 with the flocked fibers 60 functioning to help maintain the loaded coating material to the coating-receiving surface such as a wall or a floor while also acting as a brush for the applicator. Roller insert 55 comprises cylindrically shaped base member 56 similar to the base member 32 of the roller insert 31 of FIG. 5. Cylindrically shaped base member 56 includes an exterior surface 57 containing a plurality of tiny hooks 58 of plastic or the like extending therefrom. The plurality of tiny hooks 58 function to secure replaceable coating pad 59 to the exterior surface 57 of cylindrically shaped base member 56 when the a loop side 63 of the replaceable coating pad 59 is pressed against the exterior surface 57 of the cylindrically shaped base member 56 causing the plurality of tiny hooks 58 of the cylindrically shaped base member 56 to catch in a plurality of small hair-like loops 54 of replaceable coating pad 59. Once the replaceable coating pad 59 is no longer usable, replaceable coating pad 59 may be replaced for a fresh replaceable coating pad 59 by separating the used coating pad 59 from the cylindrically shaped base member 56 and securing a fresh replaceable coating pad 59 to the cylindrically shaped base member 56.

FIG. 10 shows a side view of an alternative embodiment of a replaceable coating pad 64 similar to the replaceable coating pad 44 of FIG. 7 in that replaceable coating pad 64 comprises a layer of fabric 65 having a first side 66 identified by a plurality of tiny hooks 67 of plastic or the like extending therefrom. However, unlike replaceable coating pad 44, layer of fabric 65 includes a second side 68 having a plurality of fibers 69 that are directly flocked onto the second side 68 of the layer of fabric 65 with plurality of flocked fibers 69 functioning to help maintain the loaded coating material to the coating-receiving surface such as a wall or a floor while also acting as a brush for the applicator. Replaceable coating pad 64 may be used in conjunction with various coating applicator tools having a base member with a side or surface containing a plurality of small hair-like loops similar to the base member 52 of coating applicator tool 51 to enable the securement of replaceable coating pad 64 to the base member in a similar manner as described for applicator tool 51.

FIG. 11 shows a side view of an alternative embodiment of a replaceable coating pad 70. Replaceable coating pad 70 is similar to the replaceable coating pad 44 of FIG. 7 in that replaceable coating pad 70 comprises a layer of fabric 71 having a first side 72 identified by plurality of small hair-like loops 73 located thereon. However, unlike replaceable coating pad 44, layer of fabric 71 includes a second side 74 having a plurality of fibers 75 that are directly flocked onto the second side 74 of the layer of fabric 71 with plurality of flocked fibers 75 functioning to help maintain the loaded coating material to the coating-receiving surface such as a wall or a floor while also acting as a brush for the applicator.

Replaceable coating pad 70 may be used in conjunction with various coating applicator tools having a base member with a side or surface containing a plurality of plurality of tiny hooks similar to the base member 56 of coating applicator tool roller insert 55 to enable the securement of replaceable coating pad 70 to the base member in a similar manner as described for applicator tool 51.

In regards to an example of a process of manufacturing the coating applicator tool of the present invention, the process starts with a flat sheet of a substrate that may comprise of a variety of materials including but not limited to various plastics, phenolic paper, various types of natural fibers, natural cellulose, and various type of metal.

A surface of the sheet of substrate first goes through a flocking process. Flocking allows for the coating of the surface of the substrate with any of a variety of materials. Flocking materials, which could be successfully employed to the sheet of substrate include fibers of either organic or synthetic origin, such as cotton, wool, rayon, nylon, plastic, or other materials. These materials may be chopped, cut to random lengths, or cut to precision lengths. The flocking material may be applied to the substrate by various methods including but not limited to electrostatic coating.

In the electrostatic coating process, the flocking fibers are coated with a medium to make them electrically conductive or charged. The surface of the substrate is coated with an adhesive. The adhesively coated substrate surface is then passed through a static charged field and the flocked fibers are electronically drawn to it, causing them to become embedded in the adhesively coated substrate surface. The static electricity makes the fibers erect and stand straight on end, orienting the fibers generally perpendicularly to the surface of substrate. Once the surface of substrate has been flocked with the fibers, the adhesive on the substrate may then be heated, chemically cured or air dry to allow the adhesive to hardened.

Once the adhesive has hardened, the substrate may then be cut to size. If desired the substrate may also manipulated such as by a stamping process, a bending process or by heat and formed into a desired shape. The resultant product may them be used to form the applicating surface of the coating applicator tool of the present invention.

I claim:

1. A coating applicator tool comprising:
a base member having a first surface and a second surface;
a handle connected to said second surface of said base member; and
a plurality of flocked fibers supported on said first surface of said base member with said flocked fibers maintaining coating materials to a coating-receiving surface and distributing coating materials to said coating-receiving surface.

2. The coating applicator tool of claim 1 Wherein said plurality of flocked fibers are directly flocked to said first surface of said base member.

3. The coating applicator tool of claim 1 wherein said handle is attached to said base member through a sliding engagement of an attaching end of said handle with a pair of slots located on said second surface of said base member.

4. The coating applicator tool of claim 1 wherein said handle includes a joint allowing said base member to swivel thereabout.

5. The coating applicator tool of claim 1 wherein said base member comprises a roller insert having a cylindrically shaped body.

6. The coating applicator tool of claim 1 including a replaceable coating pad removably secured to said first surface of said base member, said replaceable coating pad having a surface supporting said flocked fibers thereon.

7. The coating applicator tool of claim 6 wherein said flocked fibers are directly secured to said surface of said replaceable coating pad.

8. The coating applicator tool of claim 6 wherein said replaceable coating pad includes a pair of arms extending from opposing ends of said replaceable coating pad, said pair of arms engaging a set of corresponding slots of said base member to removably secure said replaceable coating pad to said base member.

9. The coating applicator tool of claim 6 wherein said replaceable coating pad comprises metal, wood, plastic, phenolic paper, cardboard, various types of natural fibers, natural cellulose, or an elastomeric material.

10. The coating applicator tool of claim 6 wherein said replaceable coating pad includes a pair of curve-shaped ends located at opposing ends of said replaceable coating pad, said curve-shaped ends of said replaceable coating pad engaging a pair of corresponding arms extending at opposing ends of said base member to removably secure said replaceable coating pad to said base member.

11. The coating applicator tool of claim 6 wherein said replaceable coating pad comprises a hook-and-loop fastener and said first surface of said base member comprise a surface securable to a surface of said replaceable coating pad.

12. The coating applicator tool of claim 11 wherein said replaceable coating pad includes a first side having a plurality of tiny hooks extending therefrom and a second side having said flocked fibers directly secured thereto.

13. The coating applicator tool of claim 11 wherein said replaceable coating pad includes a first side having a plurality of small hair-like loops extending therefrom and a second side having said flocked fibers directly secured thereto.

14. The coating applicator tool of claim 11 wherein said replaceable coating pad includes a first side having a plurality of tiny hooks extending therefrom and a second side having a plurality of small hair-like loops extending therefrom.

15. A coating applicator tool comprising:
a base member having a first surface and a second surface;
a handle connected to said second surface of said base member; and
a replaceable coating pad comprising a hook-and-loop fastener, said replaceable coating pad having a first surface securable to said first surface of said base member by a pressure contact and a second surface supporting a plurality of flocked fibers thereon with said flocked fibers maintaining coating materials to a coating-receiving surface and distributing coating materials to said coating-receiving surface.

16. The coating applicator tool of claim 15 wherein said base member comprises a roller insert having a cylindrically shaped body.

17. The coating applicator tool of claim 15 wherein said first side of said replaceable coating pad includes a plurality of tiny hooks extending therefrom and said second side of said replaceable coating pad having said flocked fibers directly secured thereto.

18. The coating applicator tool of claim 15 wherein said first side of said replaceable coating pad includes a plurality of small hair-like loops extending therefrom and a second side having said flocked fibers directly secured thereto.

19. The coating applicator tool of claim 15 wherein said replaceable coating pad includes a first side having a plurality of tiny hooks extending therefrom and a second side having a plurality of small hair-like loops extending therefrom or vice versa.

20. A method of making a coating applicator tool comprising the steps of:
coating a plurality of flocking fibers with a medium to make said flocking fibers electrically conductive or charged;
coating a surface of a substrate with an adhesive;
directing said adhesively coated surface of said substrate through a static charged field;
to electronically drawing and embedding said flocking fibers to said adhesively coated surface of said substrate;
hardening said adhesive on the substrate; and
prepping said substrate to form said coating applicator tool.
